(19) United States
(12) Patent Application Publication
(10) Pub. No.: US 2026/0105267 A1
(43) Pub. Date: Apr. 16, 2026

(54) A LEARNING AID EMPLOYING TEXT-OVER-TEXT VISIBILITY REDUCTION

(71) Applicant: Daniel Bishop, Pflugerville, TX (US)

(72) Inventor: Daniel Bishop, Pflugerville, TX (US)

(21) Appl. No.: 19/359,173

(22) Filed: Oct. 15, 2025

Related U.S. Application Data
(60) Provisional application No. 63/707,242, filed on Oct. 15, 2024.

(51) Int. Cl. G06F 40/58; G06F 40/169; G09B 19/06

(52) U.S. Cl. CPC G06F 40/58; G06F 40/169; G09B 19/06

(57) ABSTRACT

A method for dynamically displaying a translation of a source word in a written work. Each text page of the written work is singly displayed on a user display. The method comprises determining a translation of a source word that appears on a current page of the written work. The method further determines a number of pages on which the source word was previously displayed to the user prior to display of the source word on the current page. The translation of the source word is displayed proximate to the source with a visibility determined according to the number of pages value. The same visibility is used for all occurrences of the source word on a text page.

### CROSS REFERENCE TO RELATED APPLICATIONS

The present application claims priority under 35 U.S.C. 119 (e) to the provisional patent application filed on Oct. 15, 2024 and assigned application No. 63/707,242 (Attorney Docket 16915-002P). The contents of that application are incorporated herein.

### FIELD OF THE INVENTION

The present invention relates to a computer-based learning aid employing text-over-text visibility reduction as the user learns a new language.

### BACKGROUND OF THE INVENTION

Learning a language is hard! Completing years of classes or a software-based home study course can provide basic language competency, and allow speakers to navigate real-world situations. But many learners soon become disillusioned with their progress, frustrated because they cannot navigate even simple books on their own without looking up words one at a time, over and over again.

As an avid learner of languages, the inventor completed a Duolingo course for Italian, and then bought an Italian-language copy of Harry Potter and the Sorcerer's Stone, and attempted to read it. He read only about two pages before giving up. Why? Because he had to look up so many individual words that by the time he finished translating a single sentence, he had lost the emotional and contextual meaning of the sentence.

Being a linguist, the inventor is familiar with the concept of “parallel corpora,” i.e., the display of parallel text (one or more translations, for example) proximate the original language text. Many books are available in multiple languages in a parallel corpus format. Numerous holy texts, which are now available in multiple languages, were among the earliest.

Utilizing an Italian translation of the Harry Potter book and the original English version, the inventor was better able to navigate individual sentences and discover the meaning of various Italian words that he was not familiar with. Because he had a basic understanding of the Italian language and the story line, he did not necessarily require the translation of every word. However, his eyes were still flipping between the two versions (i.e. the original language text and its Italian translation), considerably slowing his reading and comprehension as he was constantly losing his place in both books.

Exacerbating the translation process, it is known that translations are not always conducted on a one-to-one or word-for-word basis. Therefore, certain terms or even entire sections of books could be meaningfully different in the translated version when compared to the original-language version.

### BRIEF DESCRIPTION OF THE FIGURES

Embodiments of the present invention will now be described in more detail, with reference to the attached drawings in which:

FIG. 1 illustrates steps of an algorithm for use in implementing one embodiment of the present invention.

FIG. 2 illustrates an exemplary foreign language source text and target translated text.

FIG. 3 illustrates a computer system for use in practicing the invention.

### DETAILED DESCRIPTION OF THE INVENTION

### Terminology

Throughout this document, the terms “word”, “token”, “term”, “atomically-translatable concept” and “phrase” are mostly used interchangeably; notably, “phrase” is the only wholly-separate concept, comprising a plurality of words or tokens.

A screentip is a small pop-up box or window of descriptive text that appears when a user hovers a cursor or mouse pointer over a user interface element, such as a button, icon, image, or hyperlink. In the context of the present invention, the user interface element is typically a word or phrase, but hovering a mouse pointer is not required to display a screentip, e.g., a translation or definition of the user interface element.

A word in English (defined as a single distinct and meaningful element of speech or writing that when combined with others forms a sentence that conveys information) does not always translate on a one-to-one basis to other languages. Consider “a menudo” in Spanish, which would appear to be “two words”, but translates to the English single word, “often.” Or the word, “madrugar” in Spanish, which in English translates to, “(to) wake up early.”

In the field of computational linguistics, a “token” often refers to a word, but can also comprise sub-word chunks. An “atomically-translatable concept” for the purposes of this document refers to terms like “a menudo” as a single concept for translation. A phrase, by contrast, is therefore not any of the above, but rather something more akin to a verbal phrase or an up-to-a-sentence-long string of words.

For the purposes of this specification, however, all of the above terms can be used when considering the translation and placement of translations for and from different languages in a mostly-interchangeable manner.

### DESCRIPTION OF INVENTION

Some existing approaches for learning definitions or translations of words include “hover hints,” that is, long-tapping or hovering a mouse over a term (or performing another interaction operation) causes a temporary pop-up window to appear with the definition or translation appearing in the window. Typically, the definition remains in the window for a fixed time. The inventor rejected the “hovering” approach as too cumbersome and ineffective as a teaching aid for the reader.

Also, the temporary pop-up window approach is not viable when reading a whole sentence (or a whole page) as the reader will often benefit from quickly glancing back at the translated word(s) recently presented, but a temporary pop up window will likely have disappeared when the user looks back.

Consider a related scenario for learning Italian (or any other language) by concurrently reading two versions of a book each written in a different language. It is difficult for the reader to retain the last-read place on a page (and remember the content of the last sentence read on that page) of the first book when the reader's eyes move from the first book to the second book (or from one screen to another screen) to see the translated text.

Thus, the temporary pop-up window technique is not an acceptable approach as it does not provide an opportunity to truly learn and thereby synthesize the translation.

The inventor also realized that the prior art feature of providing equal “extra attention” to every translated word was problematic and for various reasons explained herein, not effective for learning a new language.

Having learned in his linguistics studies about furigana, (https://en.wikipedia.org/wiki/Furigana) where small syllabic text is placed alongside logographic text as a reading aide, and having learned about the HMTL “ruby” tag to implement it, the inventor experimented with using different techniques for a cross-language aide. The effort was immediately successful!

The inventor visually represented his learning journey with an inventive “eventually reduced-to-zero” visibility for a translated word. According to one embodiment of the invention, each time a source word appears on a page of text (as displayed on a display screen) the translation (also referred to as the translated word or phrase) is displayed proximate to the source word. And the translation appears with the same visibility each time it occurs on that page.

As used herein, opacity refers to the degree or extent of visibility of a word or phrase displayed on a screen or monitor. Thus, opacity and visibility may be used interchangeably herein. Reduction in visibility is also referred to as an increase in the transparency of the translation or a decrease in the opacity of the translation.

For example, if the source word appears eleven times on a page the translation appears for eleven times on that page, and each of the eleven appearances is presented with the same visibility. If the source word appears only once on a page, the translation appears only once on that page.

In one embodiment the translation may not appear for every occurrence of the source word on a single page. For example, the translation may appear for alternate appearances of the source word on the page. This may be a user-configurable parameter.

All translations of the source word appear with equal visibility for each occurrence of the source word on the page. When the source word appears on a subsequent page the visibility of the translation is reduced. An algorithm, further described below, determines the amount of visibility reduction for the translation on the subsequent page.

In addition to appearance of the translation at reduced visibility on subsequent pages, the translation will also appear with reduced visibility if the user returns to a previous page where the source word is presented.

For example, in one embodiment the visibility is reduced by 10% for all occurrences (displays) of the source word on a subsequent page or on a previous page. If the word “cinco” appears five times on page 23, the visibility is identical for each occurrence of the translation “five” on page 23. If the word “cinco” appears once (or many times) on page 24, the visibility of that translation is reduced by 10% for all occurrences on page 24 due to the appearance of the source word on page 23. The visibility reduction for page 24 would have been the same whether “cinco” appeared once or ten times on page 23. The appearance of the source word on a previously displayed page (irrespective of how many times it appeared on the previously displayed page) is the controlling parameter.

By reducing the visibility by 10%, for example, makes the translation less visible to the reader. This feature encourages the reader to learn the translation of the source word when it first appears.

The system does not pre-populate the source words on page 24 with reduced visibility translations. Instead, when the reader navigates away from page 23 to page 24 the algorithm updates the “seen” count for the source words on page 23. Then when the reader turns to page 24, the algorithm checks the “seen” count (which now includes one additional count for the one or more appearances on page 23) and displays the translation with the 10% visibility reduction from the occurrences on page 23.

Generally, when the reader navigates to a new page, either before or after the current page, the system “looks up” all words on the new page to determine the number of pages on which each word was “seen.” Then the visibility of each translation on the new page is set based on the total number of pages on which the source word had previously appeared and the number of pages on which the source word was “seen” since the last time the reset function for that source word was enabled.

When a user begins to read text or a book, all words are candidates for translation and translations appear proximate to the source word as the page is displayed. As the user progresses through the book, the translation appears for fewer appearances of the source words as controlled by the algorithm, i.e., the system counts the number of pages on which a translated word had been seen and accordingly reduces the visibility for subsequent translations.

The system also stores the number of times a source word has been seen and the number of pages on which the source word appeared as the user reads different text or books and accordingly displays the translation based on the algorithm. Thus, the system does not translate all words in a text or a book the user later reads. Translations appear only for those source words the user has not previously seen or has not previously seen to the point where the algorithm displays the translation with zero visibility.

Note that the application described immediately above requires that data (e.g., number of read pages on which a source word appeared or the number of times a source word was seen on all read pages) collected while the user was reading a first book on a first device (a mobile phone for example) must be transferred to a second device (a laptop computer for example) as the user reads a second book. With historical data available on the second device, the algorithm executing on the second device can accurately implement the visibility parameters as determined according to the algorithm. The data collected while reading the first book on the first device can be conveniently transferred to the second device using a USB flash drive.

A preferred application for the present invention employs the algorithm in conjunction with a website that offers the user/reader multiple different types and genres of reading material. For example, the website can host literature, publications, texts, articles, magazines, newspapers, books, and all types of reading material. A user logs onto the website and can chose from among the plethora of reading material. The user then reads the selected written work as the system singly displays each page, that is the pages are displayed individually; after the user finishes reading one page, the user requests delivery of the next page.

The website incorporates the system of the present invention, such that as the user switches from one book or textual material to another, the system tracks the number of pages on which a translation or definition for a source word had been displayed and/or reset and uses the algorithm to determine the visibility or opacity for the next occurrence of that word on a different page, including, advantageously, a page in different reading material. Of course, the user can log into the website using any convenient device since all the historical data as to the number of times the word was seen, number of pages on which it was seen, learned, reset, etc. is stored on the website.

Generally, the invention is applicable to all forms and formats of a written work and provides a definition, translation, etc. of the source words or phrases within the written work. As used herein, a written work is interpreted to include text that appears on a display screen, such as the display screen of a computer or mobile phone, as well as text that appears in a traditional written work where ink is applied to paper.

The rate for visibility reduction can be set by the reader; the default value is 10% in one embodiment. This value determines the number of incremental reductions before the translation is completely invisible, i.e., the translation is simply not presented. This change in visibility of the translation applies to source words that may be presented on different pages in a single work and in other written and printed works. As mentioned above, all appearances of the translation for a source word on a single page have the same visibility.

The reader can slow the rate of visibility reduction from the default value of 10% to 5% (or to a different value less than 10%) for troublesome words and phrases. It is with considerable joy that the inventor asserts this method works very well for learning new terms mid-read!

The reader can also increase the rate of visibility reduction (within the algorithm) to greater than the default value of 10% for familiar source words, indicating the reader's confidence and in most-to-all cases, learn words with fewer repetitions.

The system also allows the user to mark a source word as “known” or “learned” and thus the translation does not appear for any occurrences of that source word on any page of the work the reading is currently reading and on any other written or printed work.

Additionally, the system is configurable on a part-of-speech-basis, defined as identifying individual source words according to the part of speech to which they pertain (e.g., noun, verb) and allowing configurable visibility rate reductions for each part of speech.

The system can also be configured to change the rate of visibility reduction (either increase or decrease) for “phrases”, i.e., more than one word.

The algorithmic rate of visibility reduction depends on the number of pages on which a source word has been seen and the number of times the user has reset the translation to full visibility. Here is an illustrative example:

V=0.1+x+y

where x is the number of pages on which the source word has been seen by the user, and y is the number of times the user reset the visibility of the source word to full visibility. The algorithm then adjusts the rate of subsequent visibility reductions for subsequent occurrences of the source word according to the parameter V.

By storing the number of pages on which a source word has been seen and the number of times the algorithm has been reset for that source word (x+y in the equation above), those source words can be stored for user review in other learning modes such as, but not limited to, flashcards, vocabulary review per page/chapter, etc.

The variable-visibility learning aide concept as set forth herein can also be applied to intra-language (as in the original furigana) learning. Instead of presenting a translation aid, the learning aide presents, for example, a definition for a new or unfamiliar source word or correct spelling for a source word. As for the translation, the definition and the correct spelling of source words is shown along with the source word and its visibility reduced as described herein,

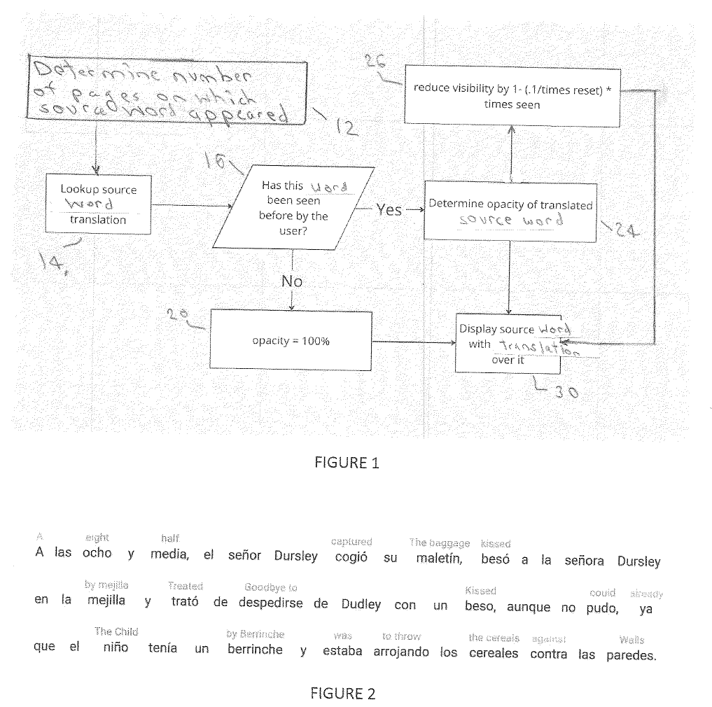

FIG. 1 illustrates a flowchart 10 for controlling the system of the invention. The flowchart is traversed for each occurrence of a source word.

At a step 12 the system determines the number of pages on which the source word has previously appeared and at a step 14 determines a translation for the source word.

Decision step 16 determines whether the source word has been seen before by the user.

A negative answer sets the display visibility at 100% at a step 20, and at a step 22 the translation is displayed proximate to the source word.

If the decision step 16 returns an affirmative answer, processing moves to a step 24 where the visibility for the last occurrence on a page is obtained and then reduced according to the controlling algorithm, with one example for calculating the visibility/opacity set forth at a step 26.

From a step 20 or a step 26, processing returns to a step 30 where the source word is displayed with the translation above or proximate thereto.

In another embodiment, in lieu of calculating the visibility reduction at step 26, if the source word has previously appeared on the instant page, the algorithm instead consulates the stored value for the visibility reduction for that word, then moves to step 30.

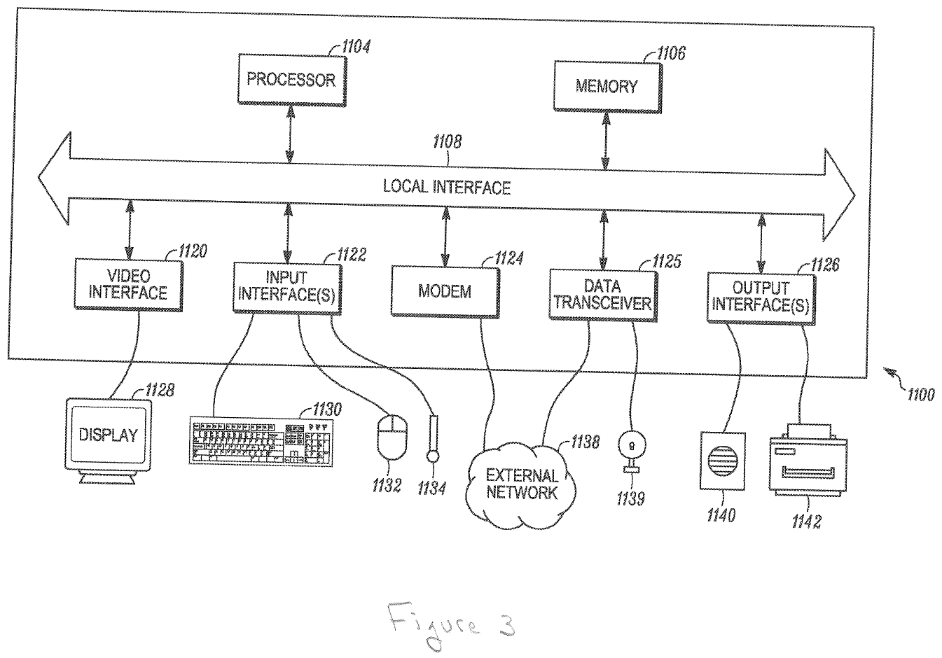

FIG. 2 depicts an exemplary source text with the translations appearing above the source words.

As described above, each time the user resets a source word to full visibility (100% visibility) the visibility for additional appearances of the source word on different pages (noting that all appearances of the source word on a single page are displayed with the same visibility) is determined, in one embodiment, according to the following formula:

Opacity=1−round((0.1/reset count)*seen count,2)

That is, a word's opacity is between 0 and 1, and this value is a function of the number of pages on which it had been seen since it was last reset, i.e., 0.1/(number of times it has been reset or reset count). The “seen count” value is set to 1 at time of initialization, that is, the first time it is seen on a page to avoid a divide by zero problem.

The final “2” causes the numerical opacity value to be rounded to two decimal places. The decimal value derived from the formula, which will be between 0.0 and 1.0 inclusive, is multiplied by 100% to obtain the percent opacity for display of the translation.

At the fifth instance of presenting “gato,” which would now be half-visible, the user realizes she is having trouble remembering the translation and clicks the source word. This operation resets the source word to total visibility and the visibility decay rate is also reset from its previous value of 10% per each occurrence to 8%, for example, per appearance, noting again that all appearance on a page are displayed with the same visibility.

Here are two examples.

Opacity=1−round((0.1/reset count)*seen count,2)

For the first time the source word is seen and if it was never reset, then seen=0, and reset=0, but both are inserted into the formula as +1 to avoid a divide by 0 issue.

1−round((0.1/1)*1,2)=0.1, reduce visibility to 90%

After the source word has been seen on five pages, but has not been reset seen=5, reset=0 (so use +1 for the reset value)

1−round((0.1/1)*5,2)=0.5, 50% visibility after seeing the source word 5 times

Note that the formula above calculates the opacity value for the first occurrence of the source word after it has been reset and the opacity value for each page on which the source word appears after a reset.

After the source word has appeared on an additional twelve pages (for example, in one embodiment), the translation no longer appears. If the user clicks on “gato” again, the translation is 100% visible again and the decay rate is now reduced according to the opacity formula above.

In the above example, even if “gato” was clicked immediately or after it was seen on 100 pages, the equation increments the number of times reset by “1” and reduce the number of pages on which it appeared to “0”.

In the various examples described herein, the source word part of speech or other algorithm settings, could also contribute to the speed (increased or decreased) of decay of the displayed translation. The factors and limits employed by the algorithm are user controllable.

See FIG. 2 for an example where multiple words are at multiple stages of visibility.

Additional features of the invention include:
Provides visualization of text in a source/learning language and in a target/known language, with the target language displayed above or proximate to the source language, thereby allowing the user to see the translation “at-a-glance.”
As the source word is seen on many occurrences and on many different pages over time, the system algorithm reduces visibility of the translation until the translation is invisible/removed.
Clicking/tapping on a word that is either partially or completely transparent (visibility reduced to 0) resets the source word such that translations will reappear for subsequent appearances of that source word, and decreases the rate at which future translations will ‘decay’ to transparency or zero visibility.
Via another interaction method (e.g., clicking and selecting an option in a popup, or right-clicking, long-clicking, etc.) the user indicates to the system “I already know this” and marks it as known. The translation will not appear for future occurrences of that source word.
Via the same or interaction methods similar to those described above, a user can learn more about a source word (e.g., its etymology, definitions, etc.)
For intra-language use, the source word is not widened as might be required for translations and definitions (either determined by consulting a reference source or generated by a machine learning process) are placed similarly due to a combination of available space and the number of term(s) to be defined.
A sub-algorithm determines priority for a definition if there is insufficient space to display all requested definitions per line.
Terms with significantly higher (twice or more over their competing terms) frequency of incidence within the source text are given priority in allocating available space.
If more than two source words in a line of text need to be translated or defined, the largest number of source words that can fit their definitions onto the line will take precedence.
Acronyms are assigned a second level of precedence.
As described herein, the phrase(s) or term(s) are displayed using the same graying-out algorithm as described above for translations.

The present invention can be also used to provide English-English definitions/context/etc., especially for specialized technical fields. By presenting a definition of specialized words, for example in the field of botany, the invention allows such specialized fields to be more accessible to non-learned individuals.

An exemplary system for implementing the invention includes a computing device or a network of computing devices. In a basic configuration, computing device may include any type of stationary computing device or a mobile computing device. Computing device typically includes at least one processing unit and system memory. Depending on the exact configuration and type of computing device, system memory may be volatile (such as RAM), non-volatile (such as ROM, flash memory, and the like) or some combination of the two. System memory typically includes operating system, one or more applications, and may include program data. Computing device may also have additional features or functionality. For example, computing device may also include additional data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules or other data. System memory, removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by computing device. Any such computer storage media may be part of device. Computing device may also have input device(s) such as a keyboard, mouse, pen, voice input device, touch input device, etc.

Output device(s) such as a display, speakers, printer, etc. may also be included. Computing device also contains communication connection(s) that allow the device to communicate with other computing devices, such as over a network or a wireless network. By way of example, and not limitation, communication connection(s) may include wired media such as a wired network or direct-wired connection, and wireless media such as acoustic, RF, infrared and other wireless media.

Computer program code for carrying out operations of the invention described above may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. A code in which a program of the present invention is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD). The present invention can be configured for use in a computer or an information processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general purpose computer, but rather the special purpose computer programmed to perform the disclosed algorithm.

A general purpose computer, or microprocessor, may be programmed to carry out the algorithm/steps of the present invention creating a new machine. The general purpose computer becomes a special purpose computer once it is programmed to perform particular functions pursuant to instructions from program software of the present invention. The instructions of the software program that carry out the algorithm/steps electrically change the general purpose computer by creating electrical paths within the device. These electrical paths create a special purpose machine for carrying out the particular algorithm/steps.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

FIG. 3 illustrates one embodiment of a computer system 1100 for use in practicing the invention. The system 1100 can include multiple remotely-located computers and/or processors and/or servers (not shown). The computer system 1100 comprises one or more processors 1104 for executing instructions in the form of computer code to carry out a specified logic routine that implements the teachings of the present invention. The computer system 1100 further comprises a memory 1106 for storing data, software, logic routine instructions, computer programs, files, operating system instructions, and the like, as is well known in the art. The memory 1106 can comprise several devices, for example, volatile and non-volatile memory components further comprising a random-access memory RAM, a read only memory ROM, hard disks, floppy disks, compact disks including, but not limited to, CD-ROM, DVD-ROM, and CD-RW, tapes, flash drives, cloud storage, and/or other memory components. The system 1100 further comprises associated drives and players for these memory types.

In a multiple computer embodiment, the processor 1104 comprises multiple processors on one or more computer systems linked locally or remotely. According to one embodiment, various tasks associated with the present invention may be segregated so that different tasks can be executed by different computers/processors/servers located locally or remotely relative to each other.

The processor 1104 and the memory 1106 are coupled to a local interface 1108. The local interface 1108 comprises, for example, a data bus with an accompanying control bus, or a network between a processor and/or processors and/or memory or memories. In various embodiments, the computer system 1100 further comprises a video interface 1120, one or more input interfaces 1122, a modem 1124 and/or a data transceiver interface device 1125. The computer system 1100 further comprises an output interface 1126. The system 1100 further comprises a display 1128. The graphical user interface referred to above may be presented on the display 1128. The system 1100 may further comprise several input devices (some which are not shown) including, but not limited to, a keyboard 1130, a mouse 1131, a microphone 1132, a digital camera, smart phone, a wearable device, and a scanner (the latter two not shown). The data transceiver 1125 interfaces with a hard disk drive 1139 where software programs, including software instructions for implementing the present invention are stored.

The modem 1124 and/or data receiver 1125 can be coupled to an external network 1138 enabling the computer system 1100 to send and receive data signals, voice signals, video signals and the like via the external network 1138 as is well known in the art. The system 1100 also comprises output devices coupled to the output interface 1126, such as an audio speaker 1140, a printer 1142, and the like.

This Detailed Description is not to be taken or considered in a limiting sense, and the appended claims, as well as the full range of equivalent embodiments to which such claims are entitled define the scope of various embodiments. This disclosure is intended to cover any and all adaptations, variations, or various embodiments. Combinations of presented embodiments, and other embodiments not specifically described herein by the descriptions, examples, or appended claims, may be apparent to those of skill in the art upon reviewing the above description and are considered part of the current invention.

The present invention is based on computer technology that resolves a problem specifically related to the presentation of translations of source words on a graphical user interface or display. Specifically, how the translation should be presented to best assist the user in learning the translation of the source word. The mathematical algorithm controls the visibility of the translation as it appears on the display screen based on the number of prior occurrences of the translation or based on the number of prior text pages on which the translation appeared.

Throughout the above description of the invention, reference has frequently been made a translation of a source word. Those skilled in the art recognize that the same teachings can be applied to the translation of a phrase, the definition of a source word, the correct spelling of a source word, or the explanation of a technical concept that is unfamiliar to the user. Also, source word and source text are used interchangeably herein. Generally, the invention can be considered as one that interprets a source word, providing a definition, translation, explanation, etc. for the source word.

What is claimed is:

1. A computer-implemented method for dynamically displaying an interpretation of source text of a written work, wherein each text page of the written work is singly displayed on a user display, the computer-implemented comprising performing computer-implemented operations for:
determining an interpretation of the source text appearing on a current page;
displaying the interpretation according to a display attribute, wherein the display attribute is a same display attribute for all occurrences of the source text on the current page;
determining a number of pages on which the source text was displayed to the user prior to display of the source text on the current page; and
wherein the display attribute is responsive to the number of pages on which the source text was displayed to the user prior to display of the source text on the current page.

2. The computer-implemented method of claim 1, further comprising displaying the interpretation of the source text according to a different display attribute on other pages of the written work.

3. The computer-implemented method of claim 1, wherein the same display attribute is determined further according to a number of pages on which the source text was previously displayed to the user on a text page of another written work.

4. The computer-implemented method of claim 1, wherein the same display attribute is further determined according to a number of times the same display attribute had previously been reset by the user.

5. The computer-implemented method of claim 1, wherein the display attribute relates to a visibility parameter of the interpretation on the user display.

6. The computer-implemented method of claim 1, wherein the display attribute is reduced by a predetermined amount responsive to the number of pages on which the source text was displayed to the user prior to display of the source text on the current page.

7. The computer implemented method of claim 6, wherein the predetermined amount is 10%.

8. The computer implemented method of claim 1, wherein the display attribute is controllable according to an algorithm.

9. The computer implemented method of claim 8, wherein one or more parameters of the algorithm are determined by the user.

10. The computer implemented method of claim 1, wherein the display attribute is determined according to a number of pages on which the source text was displayed to the user prior to display of the source text on the current page, and the number of times the display attribute was reset to an initial display attribute.

11. The computer implemented method of claim 1, wherein the interpretation of the source text comprises a translation of the source text or a definition of the source text.

12. The computer implemented method of claim 1, wherein the source text comprises a single word or a phrase further comprising a plurality of words.

13. The computer implemented method of claim 1, wherein the interpretation is displayed above or proximate to the source text on the user display.

14. The computer implemented method of claim 1, wherein the display attribute is responsive to a parts of speech category in which the source text is classified.

15. The computer implemented method of claim 1, wherein the interpretation comprises a translation and the source text comprises an atomically-translatable concept.

16. If the user identifies the source text as “known” subsequent occurrences of the source text do not invoke execution of the computer-implemented method of claim 1.

17. A system for dynamically displaying an interpretation of source text of a written work, wherein each text page of the written work is singly displayed on a user display, the system comprising:
a server configured to:
receive instructions from the user for selecting the written work from among a plurality of available written works
determine an interpretation of the source text appearing on a current page of the written work;
display the interpretation according to a display attribute, wherein the display attribute is a same display attribute for all occurrences of the source text on the current page;
determine a number of pages on which the source text was displayed to the user prior to display of the source text on the current page; and
wherein the display attribute is responsive to the number of pages on which the source text was displayed to the user prior to display of the source text on the current page;
a database configured to store the number of pages on which the source text was displayed to the user prior to display of the source text on the current page; and
a network interface configured to transmit the written work to the user for display on the user display, including the interpretation of the source text.

18. The system of claim 17, further comprising displaying the interpretation of the source text according to a different display attribute on other pages of the written work.

19. The system of claim 17, wherein the display attribute relates to a visibility parameter of the interpretation on the user display.

20. A method for dynamically displaying an interpretation of source text of a written work, wherein each text page of the written work is singly displayed on a user display, the method comprising:
determining an interpretation of the source text appearing on a current page of the written work;
displaying the interpretation according to a display attribute, wherein the display attribute is a same display attribute for all occurrences of the source text on the current page;
determining a number of pages on which the source text was displayed to the user prior to display of the source text on the current page; and
wherein the display attribute is responsive to the number of pages on which the source text was displayed to the user prior to display of the source text on the current page.
